(19) United States
(12) Patent Application Publication
(10) Pub. No.: US 2013/0294360 A1
(43) Pub. Date: Nov. 7, 2013

(54) System and Method for Acknowledging Multiple Frames from Multiple Communications Devices

(71) Applicant: FUTUREWEI TECHNOLOGIES, INC., Plano, TX (US)

(72) Inventors: Yunsong Yang, San Diego, CA (US); Young Hoon Kwon, San Diego, CA (US); Zhigang Rong, San Diego, CA (US); Guiming Shu, Shenzhen (CN)

(21) Appl. No.: 13/874,080

(22) Filed: Apr. 30, 2013

Related U.S. Application Data
(60) Provisional application No. 61/641,187, filed on May 1, 2012.

(51) Int. Cl. H04W 24/02; H04L 1/16

(52) U.S. Cl. CPC H04W 24/02; H04L 1/1614
USPC 370/329; 370/328

(57) ABSTRACT

A method for acknowledging messages includes receiving a polling message from a plurality of stations served by the access point, and attempting to decode the polling message received. The method also includes generating a block acknowledgement bitmap (BAB) including an indication of a result of the decoding attempt of the polling message, and broadcasting the BAB to the plurality of stations.

This application claims the benefit of U.S. Provisional Application No. 61/641,187, filed on May 1, 2012, entitled “System and Method for Acknowledging Multiple Frames from Multiple Communications Stations,” which application is hereby incorporated herein by reference.

### TECHNICAL FIELD

The present disclosure relates generally to digital communications, and more particularly to a system and method for acknowledging multiple frames from multiple communications devices.

### BACKGROUND

In many communications systems, a transmission from a communications device (such as a station, a mobile station, a user, a terminal, a subscriber, a user equipment, and the like) to a communications controller (such as an access point, a controller, a base station, a base terminal station, and the like) is often acknowledged by a transmission of an acknowledgement from the communications controller to the communications device. The acknowledgement typically informs the communications device that the communications controller received the transmission (or not) and was successfully able to decode the transmission (or not). It is noted that transmissions from the communications controller to the communications device are also often acknowledged.

A variant of IEEE 802.11 referred to as IEEE 802.11 TGah (or simply 802.11ah) is, among other things, defining a wireless local area network (WLAN) protocol, especially for sub-1 GHz carrier frequencies. Main requirements of IEEE 802.11 TGah include longer coverage area (e.g., up to 1 km), a physical (PHY) layer data rate of at least 100 kpbs, a maximum aggregate multi-station data rate of 20 Mbps, use of orthogonal frequency division multiplexing (OFDM) PHY modulation, as well as support for more than 2007 associations (i.e., stations connected to an access point) in outdoor applications.

However, overhead and efficiency of the protocol are issues for 802.11ah. Due to its PHY layer having a 10 times slower clock than the normal 802.11 PHY layer, each symbol length in 802.11ah is 10 times longer than symbol lengths in 802.11. The slower PHY layer clock and resulting longer symbol length makes it imperative that protocol overhead be minimized and protocol efficiency be maximized.

### SUMMARY OF THE DISCLOSURE

Example embodiments of the present disclosure which provide a system and method for acknowledging multiple frames from multiple communications devices.

In accordance with an example embodiment of the present disclosure, a method for acknowledging messages is provided. The method includes receiving, by an access point, a polling message from a plurality of stations served by the access point, and determining, by the access point, if the access point is able to decode the polling message received. The method also includes generating, by the access point, a block acknowledgement bitmap (BAB) including an indication of a result of the determining if the access point is able to decode the polling message, and broadcasting, by the access point, the BAB to the plurality of stations.

In accordance with another example embodiment of the present disclosure, a method for operating a station is provided. The method includes transmitting, by the station, a polling message to an access point serving the station, receiving, by the station, a block acknowledgement bitmap (BAB) from the access point, the BAB includes an indication of a result of a determining if the access point is able to decode the polling message, and receiving, by the station, a downlink time grant message from the access point.

In accordance with another example embodiment of the present disclosure, an access point is provided. The access point includes a receiver, a processor operatively coupled to the receiver, and a transmitter operatively coupled to the processor. The receiver receives a polling message from a plurality of stations served by the access point. The processor determines if the access point is able to decode the polling message received, and generates a block acknowledgement bitmap (BAB) including an indication of a result of the determining if the access point is able to decode the polling message. The transmitter broadcasts the BAB to the plurality of stations.

In accordance with another example embodiment of the present disclosure, a station is provided. The station includes a transmitter, and a receiver operatively coupled to the transmitter. The transmitter transmits a polling message to an access point serving the station. The receiver receives a block acknowledgement bitmap (BAB) from the access point, the BAB includes an indication of a result of a determining if the access point is able to decode the polling message, and receives a downlink time grant message from the access point.

One advantage of an embodiment is that using a single block acknowledgement frame to acknowledge transmissions from multiple communications devices helps to reduce communications overhead and increase communications efficiency.

A further advantage of an embodiment is that separating the block acknowledgement frame from another message frame, such as a downlink time grant message frame, allows the acknowledgements to be rapidly transmitted. Therefore, the communications devices receive their acknowledgements quickly. Furthermore, while transmitting the acknowledgements, the communications controller can proceed to perform other tasks, such as scheduling downlink (i.e., a communications controller to a communications device) transmissions, without having to hold up acknowledging the uplink transmissions (i.e., from a communications device to a communications controller).

### BRIEF DESCRIPTION OF THE DRAWINGS

For a more complete understanding of the present disclosure, and the advantages thereof, reference is now made to the following descriptions taken in conjunction with the accompanying drawing, in which:

FIG. 1 illustrates an example communications system according to example embodiments described herein;

FIG. 2a illustrates an example transmission diagram of transmissions between an AP and a plurality of stations as the AP transmits downlink data to a subset of the plurality of stations according to example embodiments described herein;

FIG. 2b illustrates an example transmission diagram of transmissions between an AP and a plurality of stations as the AP transmits downlink data to a subset of the plurality of stations, where the AP schedules the transmission of the downlink data according to example embodiments described herein;

FIG. 2c illustrates an example transmission diagram of transmissions between an AP and a plurality of stations as the AP transmits downlink data to a subset of the plurality of stations, where the AP transmits a single acknowledgement that acknowledges the multiple PS-polls according to example embodiments described herein;

FIG. 3 illustrates an example transmission diagram of transmissions between an AP and a plurality of stations as the AP transmits downlink data to a subset of the plurality of stations, where the AP transmits a block acknowledgement frame that acknowledges the multiple PS-polls, and the block acknowledgement is separate from a downlink scheduling message frame according to example embodiments described herein;

FIG. 4 illustrates an example BlockAck frame modified for use as a block acknowledgement according to example embodiments described herein;

FIG. 5a illustrates a first example relationship between a TIM bitmap and a BlockAck bitmap according to example embodiments described herein;

FIG. 5b illustrates a second example relationship between a TIM bitmap and a BlockAck bitmap according to example embodiments described herein;

FIG. 5c illustrates a third example relationship between a TIM bitmap and a BlockAck bitmap according to example embodiments described herein;

FIG. 5d illustrates an example implicit association between BlockAck bitmap positions in a BlockAck frame and starting time values in a DL Timing Grant frame according to example embodiments described herein;

FIG. 5e illustrates an example scheduling bitmap according to example embodiments described herein;

FIG. 6 illustrates an example flow diagram of operations occurring in an access point as the access point transmits downlink data to stations according to example embodiments described herein;

FIG. 7 illustrates an example flow diagram of operations occurring in a station as the station receives a downlink transmission from an access point according to example embodiments described herein;

FIG. 8 illustrates an example first communications device according to example embodiments described herein; and

FIG. 9 illustrates an example second communications device according to example embodiments described herein.

### DETAILED DESCRIPTION OF ILLUSTRATIVE EMBODIMENTS

The operating of the current example embodiments and the structure thereof are discussed in detail below. It should be appreciated, however, that the present disclosure provides many applicable inventive concepts that can be embodied in a wide variety of specific contexts. The specific embodiments discussed are merely illustrative of specific structures of the disclosure and ways to operate the disclosure, and do not limit the scope of the disclosure.

One embodiment of the disclosure relates to acknowledging multiple frames from multiple communications devices. For example, at an access point, the access point receives a polling message from a plurality of stations served by the access point, and attempts to decode the polling message received. The access point also generates a block acknowledgement bitmap (BAB) including an indication of a result of the decoding attempt of the polling message, and broadcasts the BAB to the plurality of stations. As another example, at a station, the station transmits a polling message to an access point serving the station, receives a block acknowledgement bitmap (BAB) from the access point, the BAB includes an indication of a result of a decoding attempt of the polling message. The station also receives a downlink time grant message from the access point.

The present disclosure will be described with respect to example embodiments in a specific context, namely an IEEE 802.11ah compliant communications system that receives multiple transmissions from multiple communications devices. The disclosure may also be applied, however, to other standards compliant and non-standards communications systems that receive multiple transmissions from multiple communications devices.

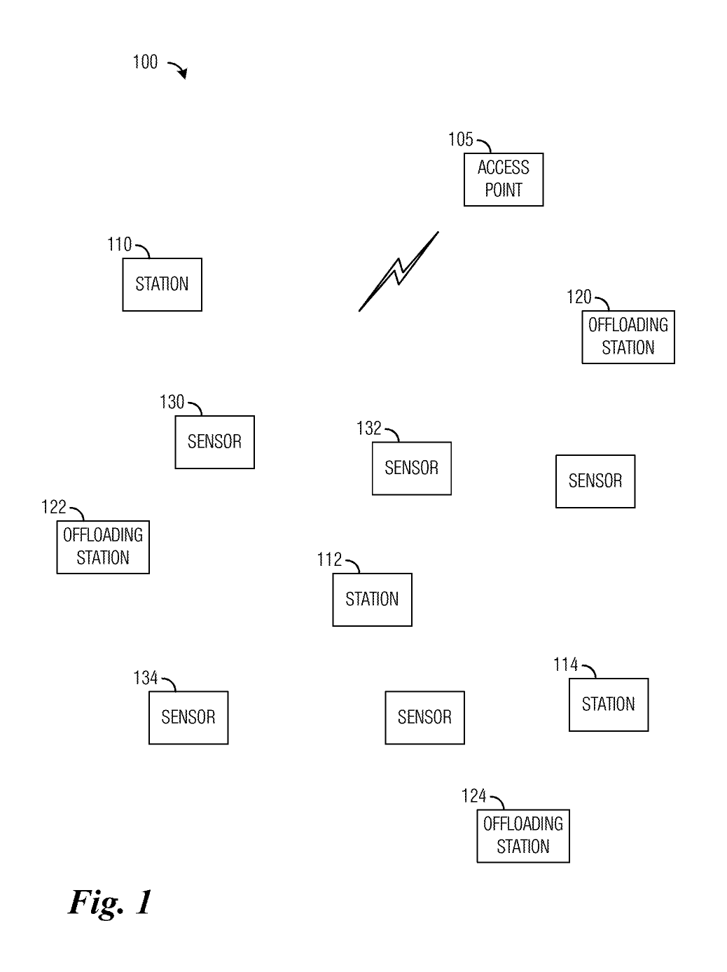

FIG. 1 illustrates a communications system 100. It is noted that communications system 100 may also be referred to as a WLAN basic service set (BSS). Communications system 100 includes an access point (AP) 105, an example of a communications controller, serving a plurality of stations (an example of a communications device). The plurality of stations may include typical stations, such as stations 110 through 114, and may include personal computers, laptops, tablets, multi-media servers, and the like. The plurality of stations may also include offloading stations, such as offloading stations 120 through 124, and may include stations that typically access services through other access networks. Examples offloading stations include cellular telephones, user equipment, and the like. The plurality of stations may also include sensors, such as sensors 130 through 134. In general, sensors are used to gather information, such as weather information, security information, position information, health information, safety information, performance information, and the like. The sensors may transmit the information through access point 105 to a server or an information aggregator. The sensors may also aggregate the information prior to transmitting the information.

While it is understood that communications systems may employ multiple access points capable of communicating with a number of stations, only a limited number of access points and stations are illustrated for simplicity.

In 802.11, including 802.11ah, an AP periodically transmits a Beacon frame. The Beacon frame typically includes the access parameters of the BSS and a traffic indication map (TIM) information element (IE) that includes an indication of which station(s), out of a plurality of stations being served by the AP, the AP has buffered data. The TIM IE may also be referred as the TIM message or simply the TIM. The process of indicating that the AP has buffered data for a station that is in a power-saving mode and wakes up intermittently at pre-subscribed time incidents in order to monitor such an indication is also known as the paging process. As an example, the TIM may include a bitmap with each station of the plurality of stations represented as a bit and the value of a particular bit indicating whether the AP has buffered data for the station represented by the particular bit. Each bit of the bitmaps may be referred to as a transmission indicator. If a station, after receiving the TIM, determines that the AP has buffered data for it, the station may transmit a power-saving poll (PS-poll) to the AP to indicate to the AP that the station is awake and is ready to receive at least some of the buffered data. After receiving the PS-poll(s), the AP directly sends a downlink (DL) data frame to the station(s) or an acknowledgement frame(s) (or simply acknowledgement(s)) if it is not ready to transmit the downlink data. After sending the acknowledgement(s), the AP will send the downlink data soon.

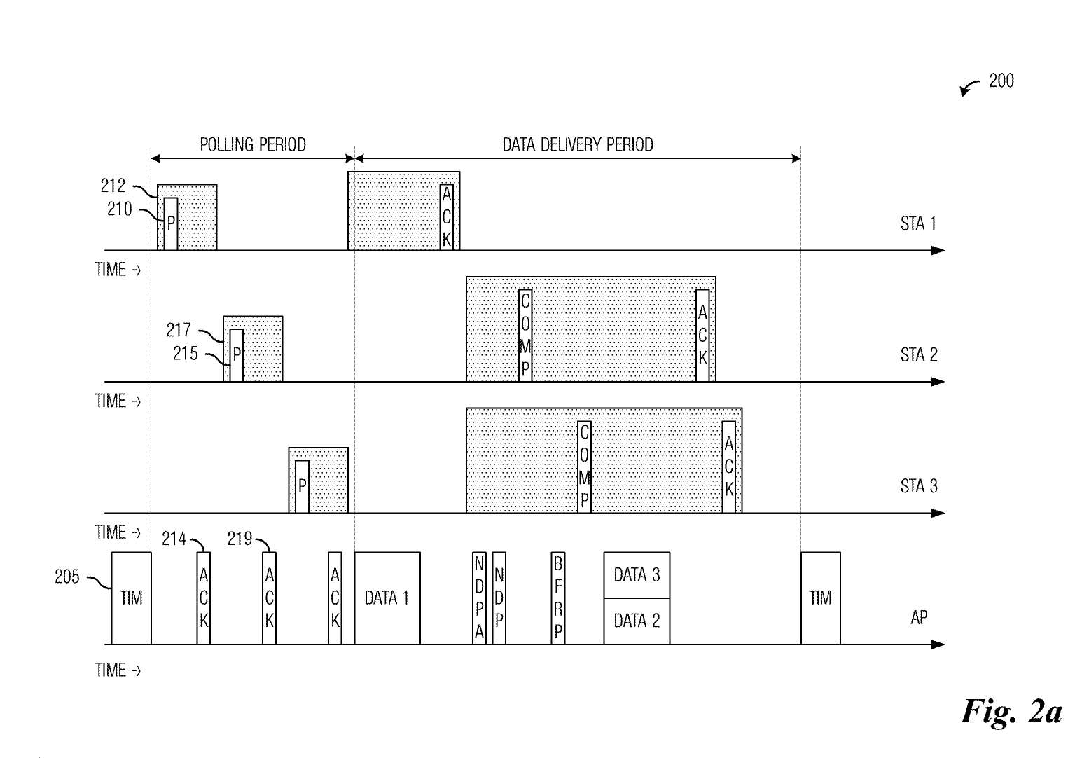

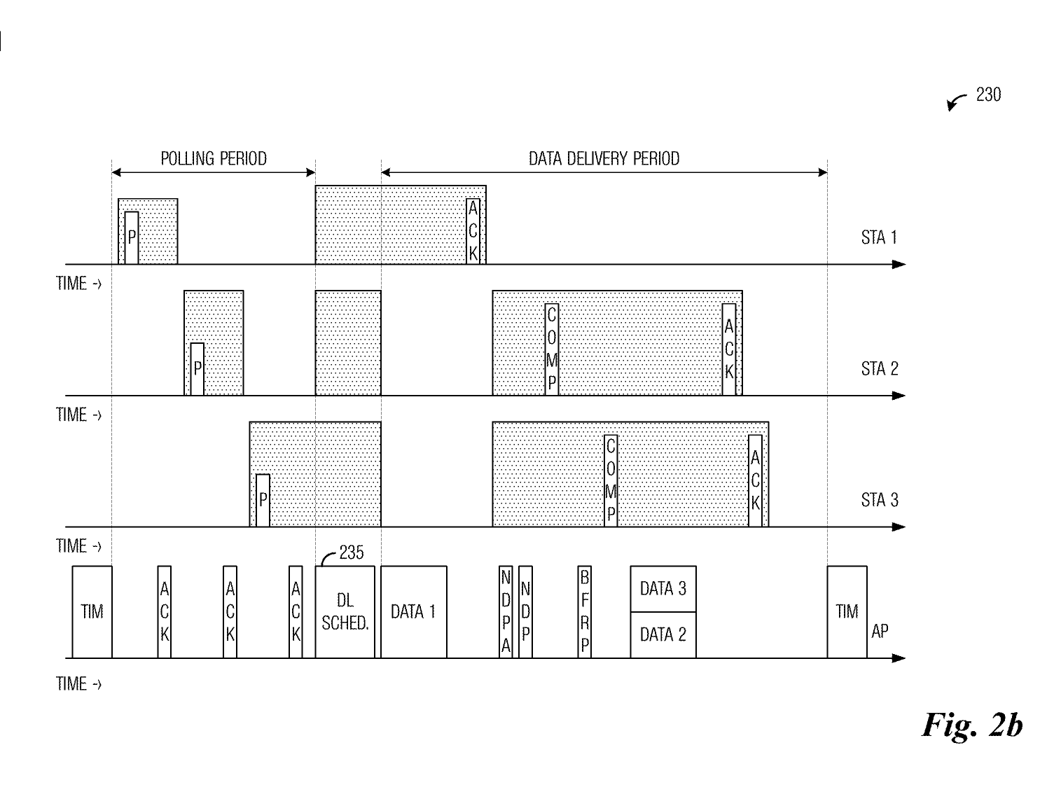

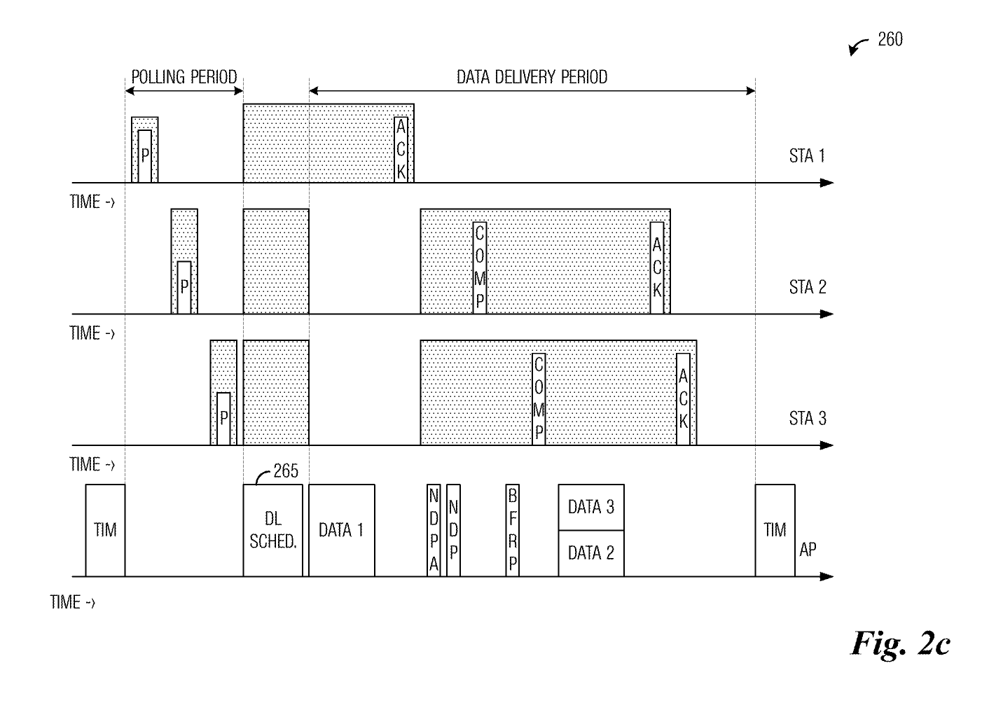

FIG. 2a illustrates a transmission diagram 200 of transmissions between an AP and a plurality of stations as the AP transmits downlink data to a subset of the plurality of stations. Transmission diagram 200 illustrates transmissions between the AP and the plurality of stations as discussed previously. At a first time, the AP transmits a Beacon frame that contains a TIM 205 including an indication of which stations the AP has buffered data. As stations receive and decode TIM 205, those that are indicated as stations that the AP has buffered data for may transmit PS-polls, such as PS-poll 210 and PS-poll 215, during a polling period. Also shown in FIG. 2a, are listening regions (shown as dotted regions, such as listening region 212 and listening region 217) when a corresponding station is listening for a transmission(s) intended for it.

When the AP receives the PS-polls, the AP may acknowledge receipt of the PS-polls by transmitting an acknowledgement for each PS-poll received. As an example, the AP may transmit acknowledgement 214 for PS-poll 210 and acknowledgement 219 for PS-poll 215. Each acknowledgement that the AP transmits may further include timing information (e.g., a beginning time and/or a length) of the downlink data that the AP will transmit to the station, based upon which the station may decide to enter a power-saving mode of operation after receiving the acknowledgement until a time at the beginning of the downlink data intended for the station. However, in this way, the AP has to decide on the data timing for a particular station without knowing all the stations that will transmit their respective PS-polls since some of the stations may not have transmitted their PS-polls. As a result, the decision on the data timing is not based on the full intelligence of all the stations that will transmit the PS-polls, thus may not be the most efficient or fair decision. Once the polling period is over, the AP may begin transmitting downlink data to the stations that transmitted PS-polls. The stations may also acknowledge receipt of the downlink data.

It is noted that the stations may send the PS-polls at about the same time, which increases the probability of collision. Since multiple stations operating within the coverage area of an AP potentially cannot listen to other station's transmissions due to long distances between the stations (commonly referred to as a hidden node problem), carrier sense multiple access with collision detection (CSMA-CD) may not work effectively. The hidden node problem may become a more significant issue in IEEE 802.11ah due to is support of an outdoor channel environment with more severe shadowing and fading, a larger coverage area, and a greater number of stations operating within the coverage area of the AP.

FIG. 2b illustrates a transmission diagram 230 of transmissions between an AP and a plurality of stations as the AP transmits downlink data to a subset of the plurality of stations, where the AP schedules the transmission of the downlink data. As shown in FIG. 2b, after receiving PS-polls from stations and acknowledging the PS-polls, the AP may transmit a downlink scheduling message frame (DL SCHED.) 235. Downlink scheduling message frame 235 may also be referred to as a downlink time grant message frame and may include information about downlink transmissions from the AP to the stations that transmitted PS-polls that were acknowledged by the AP. The information provided by downlink scheduling message frame 235 may include identifying information for a station, and a time when the AP is going to transmit the downlink data. The information may also include an amount of downlink data, a duration of the transmission, a modulation and coding scheme (MCS) used by the AP, frequency information, and the like.

As discussed above, if the AP transmits an acknowledgement to a PS-poll, it will transmit the downlink data at a later time. By deferring the transmission (and especially the final scheduling decision of the transmissions) of the downlink data to a later time (e.g., after receiving all the PS-polls), the AP may be able to schedule the downlink transmissions and potentially achieve better resource utilization and greater communications system efficiency. The deferring of the transmission (and the scheduling decision of the transmissions) of the downlink data may allow the AP to schedule the downlink transmissions for multiple stations to best utilize communications resources.

Rather than transmitting an acknowledgement for each PS-poll received, the AP may group the acknowledgements together and transmit a single acknowledgement that acknowledges the multiple PS-polls received. FIG. 2c illustrates a transmission diagram 260 of transmissions between an AP and a plurality of stations as the AP transmits downlink data to a subset of the plurality of stations, where the AP transmits a single acknowledgement that acknowledges the multiple PS-polls. As shown in FIG. 2c, during the polling period, the AP receives PS-polls from three stations. However, instead of responding to each received PS-poll with a separate acknowledgement, the AP waits and transmits a single acknowledgement that acknowledges the multiple PS-polls received. The single acknowledgement, which may be referred to as a block acknowledgement (block ack or BlockAck for short), may be included in the transmission of downlink scheduling message frame 265. Downlink scheduling message frame 265 may also include information about downlink transmissions from the AP to the stations that transmitted PS-polls. The AP may subsequently transmit the downlink data to the stations in accordance with the information included in downlink scheduling message frame 265. Although shown in Figure 2c as being transmitted after the end of the polling period, a block acknowledgement frame may be transmitted during the polling period after the AP receives multiple PS-polls.

It is noted that FIGS. 2a, 2b, and 2c are discussed in greater detail in co-assigned U.S. patent application Ser. No. 13/866,504, entitled “Method and Apparatus for Data Transmission in a Wireless Network”, filed Apr. 19, 2013, which is incorporated herein by reference.

It is noted that the block acknowledgement may be used to acknowledge the receipt of multiple PS-polls received during the polling period. Although the discussion presented herein focuses on acknowledging PS-polls using the block acknowledgement, the block acknowledgement may be used to acknowledge other received transmissions. As an example, the block acknowledgement may be used for sending (e.g., through broadcasting or multicasting) multiple acknowledgements for data and/or control frames received from multiple stations in general. As an illustrative example, a receive address of the block acknowledgement may be a broadcast or multicast address.

Generally, after receiving the PS-polls, the AP needs sufficient time for determining downlink scheduling information, especially when advanced scheduling algorithms (such as proportional fairness (PF)) are applied in selecting stations, determining transmission rates and durations for the selected stations, and the like. A few hundreds of micro-seconds may be needed before the AP can send out the downlink timing information, based on the current state of art for a typical processor in the AP, but if the AP leaves the communications channel idle for this long it may risk losing its access to the communications channel to other stations due to the nature of CSMA-CD mechanism being used in 802.11.

According to an example embodiment, it may be possible to transmit the block acknowledgement separately from other transmissions. As an illustrative example, the block acknowledgement may be transmitted separately from the transmission of a downlink scheduling message frame. The block acknowledgement frame used for acknowledging multiple PS-polls may be separately encoded and transmitted by the AP as the AP completes its detection of the PS-polls. Therefore, only a small gap of short interframe space (SIFS), which is approximately 40 microseconds long) is inserted between the end of the last PS-poll and the beginning of the block acknowledgement frame. The time involved in transmitting the block acknowledgement frame plus two SIFS s, which are inserted before and after the block acknowledgement frame, is about 600 microseconds, which is generally sufficient time for the AP to compute the downlink scheduling information.

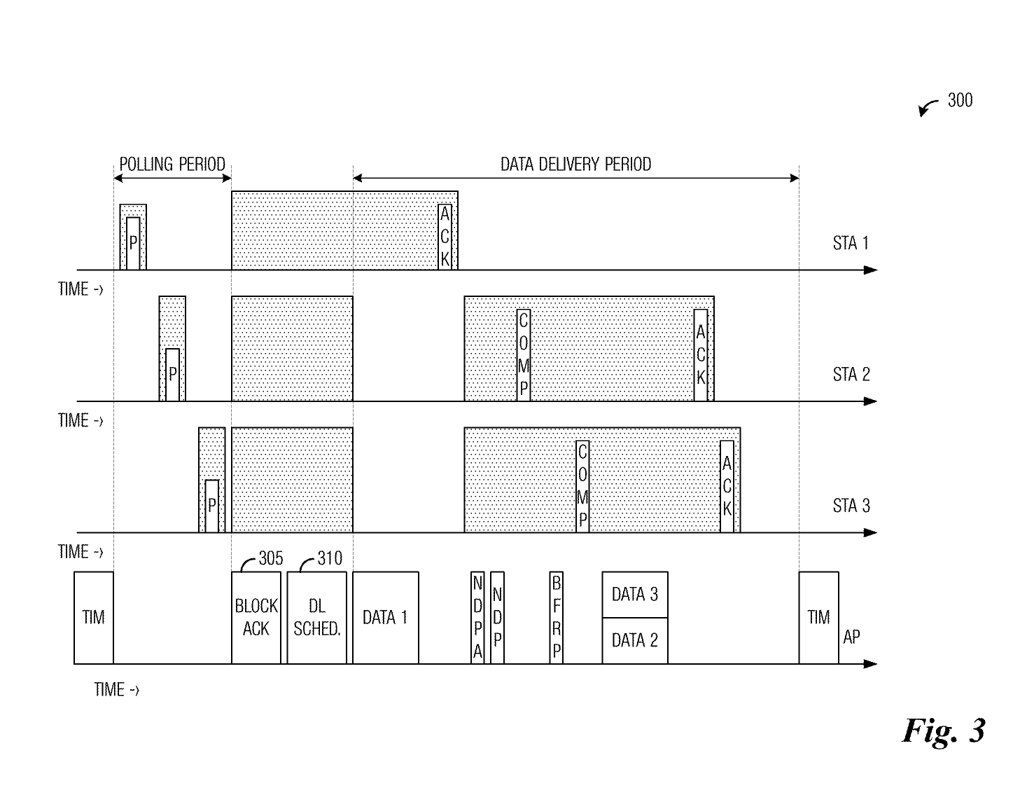

FIG. 3 illustrates a transmission diagram 300 of transmissions between an AP and a plurality of stations as the AP transmits downlink data to a subset of the plurality of stations, where the AP transmits a block acknowledgement that acknowledges the multiple PS-polls, and the block acknowledgement frame is separate from a downlink scheduling message frame. As shown in FIG. 3, the AP receives a plurality of PS-polls from a plurality of stations during a polling period. Rather than acknowledging each PS-poll, the AP holds the acknowledgements and sends a block acknowledgement frame 305 that acknowledges all of the PS-polls received.

It is noted that block acknowledgement frame 305 is encoded and transmitted separately from downlink scheduling message frame 310. The use of a separate encoding and transmission of block acknowledgement frame allows the AP to schedule downlink transmissions to a subset of the plurality of stations while block acknowledgment frame 305 is transmitted. In other words, the AP may schedule the subset of the plurality of stations and generate associated downlink scheduling information to populate downlink scheduling message frame 310 while it is transmitting block acknowledgement frame 305.

The AP may separately encode and transmit block acknowledgement frame 305 and downlink scheduling message frame 310. The AP may transmit block acknowledgement frame 305 before it transmits downlink scheduling message frame 310. The transmission of block acknowledgement frame 305 uses less airtime than transmitting individual acknowledgements for PS-polls received from the plurality of stations.

According to an example embodiment, multicasting acknowledgements generally save airtime. As a first example, consider a situation where 10 stations may send respective PS-poll as the result of receiving the TIM message. If unicasted Short ACK frames are used, transmission time may be expressible as 10×(T_ShortAck+T_SIFS)=2.8 milliseconds, where T_ShortAck represents the time duration to transmit a Short ACK frame and T_SIFS represents the duration of an SIFS, which is 40 microseconds. If a BlockAck frame is used, transmission time may be expressible as T_BlockAck+T_SIFS=0.6 milliseconds, where T_BlockAck represents the time duration to transmit a BlockAck frame. As a second example, consider a situation where 30 stations may send respective PS-poll as the result of receiving the TIM message. If unicasted short ACK frames are used, transmission time may be expressible as 30×(T_ShortAck+T_SIFS)=8.4 milliseconds. If a BlockAck frame is used, transmission time may be expressible as T_BlockAck+T_SIFS=0.64 milliseconds, where T_BlockAck is 40 microseconds longer than that in the 10-station case because the BlockAck bitmap is longer than that in the 10-station case, thus one extra OFDM symbol, which is 40 microseconds long, is needed. It is noted that substantial reductions in transmission times are achievable.

According to an example embodiment, a downlink scheduling message frame (e.g., a downlink timing grant frame) is transmitted with a short gap, e.g. an SIFS, after the BlockAck frame is transmitted, to allow those stations that have been scheduled for downlink data transmission to go to sleep and wake up at the right time to receive their respective downlink data. The downlink scheduling message frame comprises a Frame Control (FC) field, in which a sub-type field indicates that the frame is a downlink scheduling message, and a transmitter address (TA) field, which indicates the BSS Identifier (BSSID) of the access point. The downlink scheduling message frame also comprises one or more Time fields, which indicates the transmission starting time (e.g. measured from the end of the downlink scheduling message plus an SIFS) of the associated downlink data. The downlink scheduling message frame may also comprise a receiver address (RA) field, which may be used to indicate a group ID associated with the group of stations, and a Duration/ID field, which may be used to reserve the entire scheduled downlink data transmission period as a contention-free period.

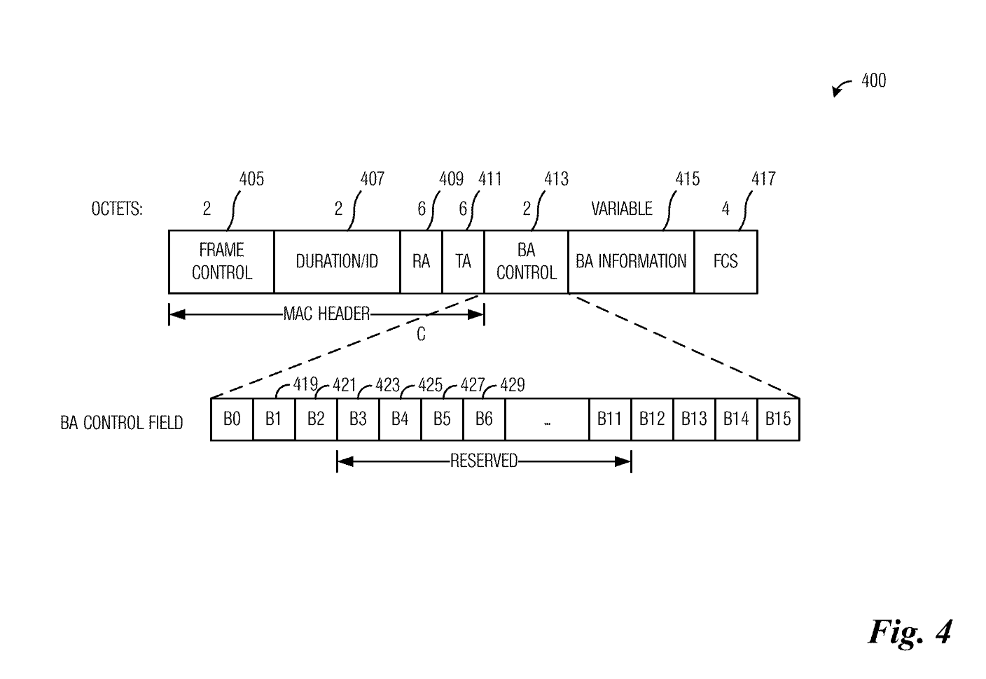

According to an example embodiment, a block acknowledgement frame, such as block acknowledgement frame 305, may reuse an existing block acknowledgment (BlockAck) frame that is currently used for acknowledging multiple data frames that are received from a single station. FIG. 4 illustrates an example BlockAck frame 400 which can be modified for use as a block acknowledgement for multiple stations. As specified in existing 802.11 specifications, such as IEEE 802.11-2012, a media access control (MAC) packet data unit (PDU) of a BlockAck frame comprises: a frame control (FC) field 405, a duration and/or identifier field 407, a receive address (RA) field 409, a transmit address (TA) field 411, a BlockAck (BA) control field 413, a BA information field 415, and a frame check sequence (FCS) field 417.

TA field 411 may indicate a basic service set identifier (BSSID) of the access point. RA field 409 may be a broadcast address, a group identifier (group ID), or a value related to a corresponding TIM or the Beacon (or Short Beacon) frame that carries the TIM, e.g., a 6 LSB bytes of a Timestamp field in the Beacon frame that carries the TIM, which can be used by a receiving station to infer the group identity.

If RA field 409 includes a broadcast address, Duration/ID field 407 may be a value related to a corresponding TIM or Beacon (or Short Beacon) frame that carries the TIM, such as the second and third LSB bytes of a Timestamp field or a FCS field or a part of FCS field in the Beacon (or Short Beacon) frame that carries the TIM, which can be used by a receiving station to infer the identity of the group of stations that the TIM is intended for. Alternatively, Duration/ID field 407 may indicate a time duration value that covers the transmission of a subsequent downlink scheduling message frame such that no station will compete with the access point for access to the communications channel during that period.

FC field 405 may include frame type and subtype fields, which indicate that the frame is a BlockAck frame. As specified in existing 802.11 specifications, bits B1 419 and B2 421 in BA control field 413 indicate one of three possible variants of a BlockAck payload contained in BA information field 415. Hence, a fourth combination of bit B1 419 and bit b2 421, e.g., “11,” is reserved. Additionally, bits B3-B12 in BA control field 413 are also reserved.

According to an example embodiment, the reserved combination of bit B1 419 and bit b2 421, e.g., “11,” may be used to indicate a new BlockAck variant that is used for multicasting multiple acknowledgements for PS-polls received from the plurality of stations.

According to another example embodiment, in order to maintain backward compatibility while facilitating possible future signaling expansion, the combination of bit B1 419 and bit b2 421, e.g., “11,” may be used in combination with other heretofore unused bits in BA control field 413, such as bits B3 423 and B4 425, to indicate the additional types of BlockAck variants. Therefore, bits B3 423 and B4 425 may serve as an extension of bit B1 419 and bit b2 421 to signal the additional types of BlockAck variants without breaking backward compatibility. It is noted that bits B3 423 and B4 425 are mentioned as example embodiments and that other bits in bits B3-B12 of BA control field 413 may be used in combination with bit B1 419 and bit b2 421 to signal the additional types of BlockAck variants. Therefore, the discussion of bits B3 423 and B4 425 should not be construed as being limiting to either the scope or the spirit of the example embodiments. As an illustrative example, bits B5 427 and B6 429 may be used in place of or in addition to bits B3 423 and B4 425 to signal the additional types of BlockAck variants. As another illustrative example, bit B3 423 alone may be used in combination with bit B1 419 and bit b2 421 to signal the additional types of BlockAck variants.

As discussed previously, the acknowledgements to the plurality of PS-polls may be carried in BA information field 415. According to an example embodiment, the acknowledgements may be represented as a BlockAck bitmap. The BlockAck bitmap may be formed in accordance with the number of stations paged in a TIM bitmap. In general, each bit in the BlockAck bitmap indicates whether a PS-poll from the associated station has been successfully received by the AP. Each bit in the BlockAck bitmap may be referred to as an acknowledgement indicator. As an illustrative example, if the bit is equal to a “1” then the AP successfully received a PS-poll from the associated station and if the bit is equal to a “0” then the AP was unsuccessful in receiving the PS-poll. It is noted that receiving a PS-poll may include both successfully receiving the PS-poll and decoding the PS-poll.

A BlockAck frame, such as BlockAck frame 400, may also be used for sending (e.g., broadcasting or multicasting) multiple acknowledgements for data and/or control frames received from multiple stations, in a backward compatible manner given there are still some reserved bits (i.e., B3-B11) left in BA Control field 413 to indicate new types of BlockAck variants. In a broader sense, RA field 409 or duration/ID field 407 may include a value that can be used to infer the identity of the group of station that send the data and/or control frames, such as a group ID of the group of stations that send the data and/or control frames, or a timer, a counter, a sequence number, an FCS field, or a portion of which, in the frame that causes the group of stations to send the data and/or control frames.

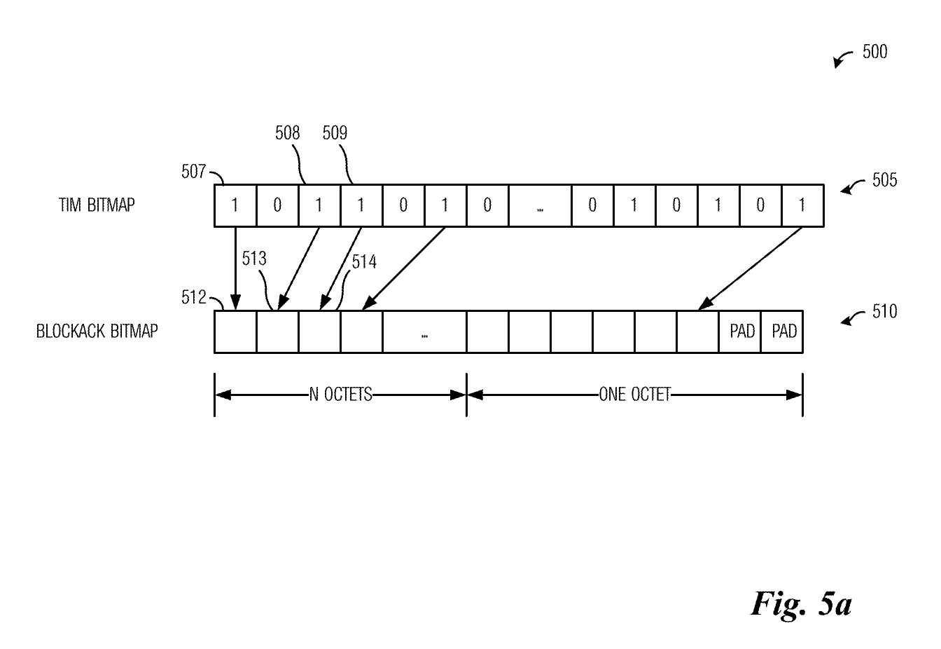

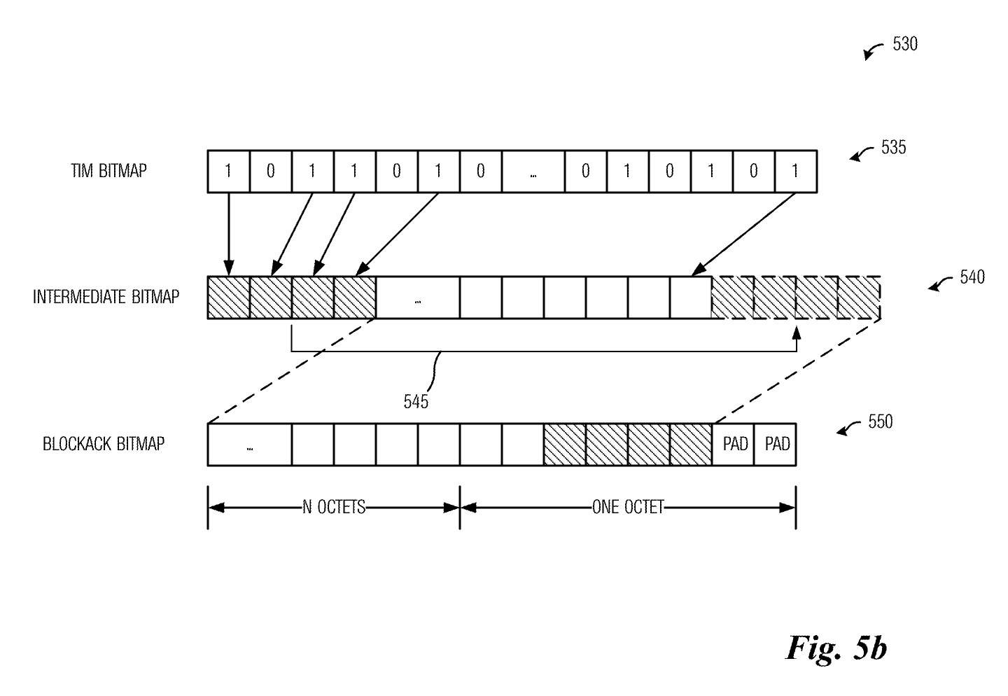

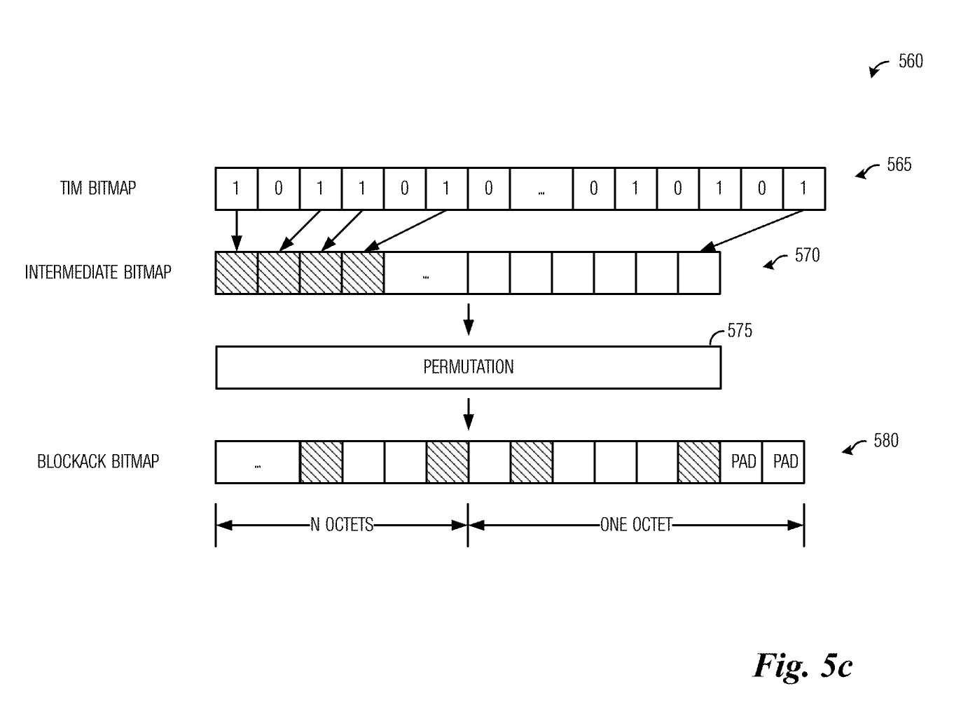

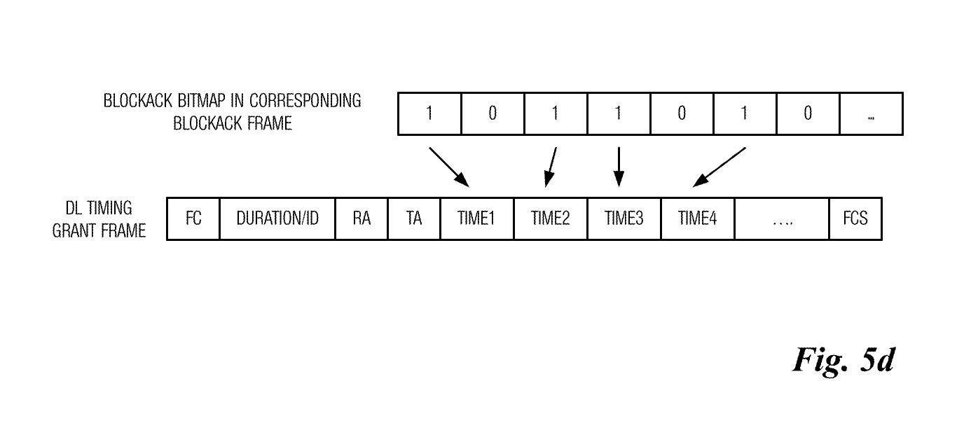

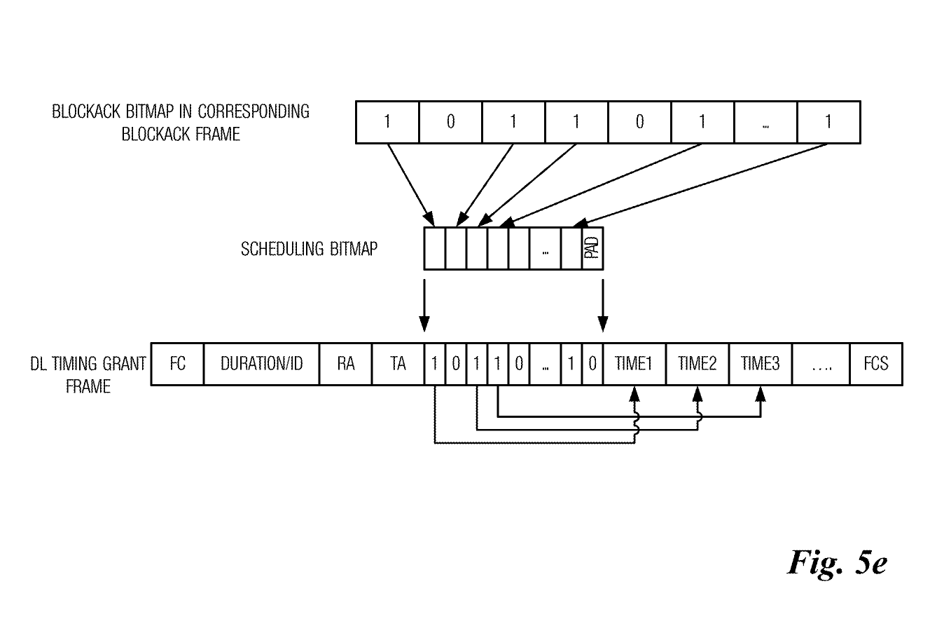

FIG. 5a illustrates a first example relationship 500 between a TIM bitmap 505 and a BlockAck bitmap 510. According to an example embodiment, bit positions in BlockAck bitmap 510 corresponds to an ordering of stations which have buffered downlink data in TIM bitmap 505. As an example, bit 512 corresponds to bit 507, bit 513 corresponds to bit 508, and bit 514 corresponds to bit 509. Since BlockAck bitmap 510 contains entries only for stations which have buffered downlink data at the AP, BlockAck bitmap 510 is always shorter than or equal to the length of TIM bitmap 505. If the number of stations with buffered downlink data is not an integer multiple of 8, one or more padding bits may be added to the end of BlockAck bitmap 510 to make it an integer multiple of 8.

FIG. 5b illustrates a second example relationship 530 between a TIM bitmap 535 and a BlockAck bitmap 550. According to an example embodiment, BlockAck bitmap 550 may correspond to a rotated or cyclically shifted order of TIM bitmap 535. In other words, bit position in BlockAck bitmap 550 may correspond to a rotated or cyclically shifted order by which the stations with buffered downlink data at the AP appear in TIM bitmap 535. An intermediate bitmap 540 may represent a BlockAck bitmap without the rotation or cyclic shift (such as in FIG. 5a). A rotation or cyclic shift 545 applies the rotation or cyclic shift as specified to produce BlockAck bitmap 550. It is noted that the amount of the rotation or cyclic shift may be a function of a counter or a system time value. If the number of stations with buffered downlink data is not an integer multiple of 8, one or more padding bits may be added to the end of BlockAck bitmap 550 to make it an integer multiple of 8.

FIG. 5c illustrates a third example relationship 560 between a TIM bitmap 565 and a BlockAck bitmap 580. According to an example embodiment, BlockAck bitmap 580 may correspond to a permutation of TIM bitmap 565. In other words, bit position in BlockAck bitmap 580 may correspond to a permutation of an order the station with buffered downlink data at the AP appear in TIM bitmap 565. An intermediate bitmap 570 may represent a BlockAck bitmap without the permutation (such as in FIG. 5a). A permutation 575 applies the permutation as specified to produce BlockAck bitmap 580. It is noted that permutation 575 is known at both the AP and the stations. If the number of stations with buffered downlink data is not an integer multiple of 8, one or more padding bits may be added to the end of BlockAck bitmap 580 to make it an integer multiple of 8.

According to an example embodiment, since the BlockAck bitmap has been transmitted (in a BlockAck frame) earlier than the downlink scheduling message (in a DL Timing Grant frame), the identity of the scheduled stations may be implicitly associated with the Starting Time values in the DL Timing Grant frame by the order of the “1” bits in the BlockAck bitmap in the corresponding BlockAck frame sent earlier, as illustrated in FIG. 5d. In order to allow the AP to not schedule a station, of which the corresponding acknowledgement bit in the BlockAck bitmap is “1”, for example due to the congestion condition and a lower priority of the station, the AP may use a special Time value, e.g., “00000000”, assuming each Time value takes one octet, to indicate to the corresponding station that its buffered data has not been scheduled for transmission.

According to an alternative example embodiment, instead of using the special Time value, a scheduling bitmap is inserted in the DL Timing Grant frame to indicate among the stations whose BlockAck bitmap bit is “1,” whether a station has been scheduled for downlink data transmission, as illustrated in FIG. 5e. Hence, the Scheduling bitmap is a subset of the BlockAck bitmap, and may take less air time to be transmitted. Padding bits (“i.e. “0” bit) may be added to the end of the Scheduling bitmap to make the bitmap fit into a multiple integer of octets. Then the Starting Times are provided according to the order of “1” bits in the Scheduling bitmap.

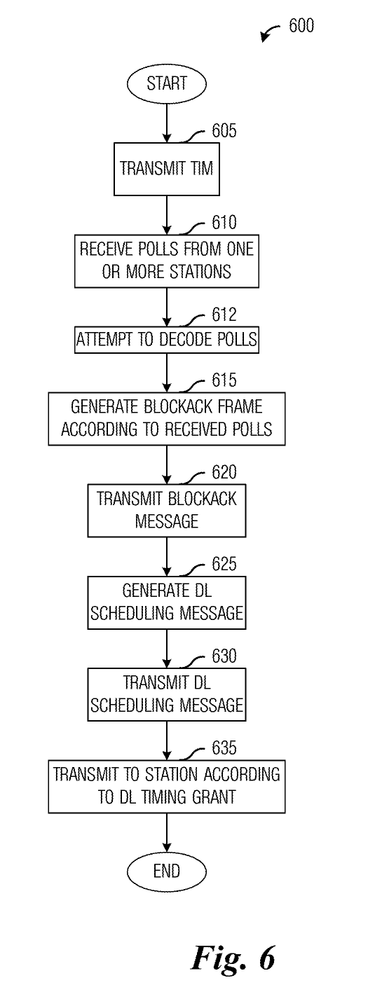

FIG. 6 illustrates a flow diagram of operations 600 occurring in an access point as the access point transmits downlink data to stations. Operations 600 may be indicative of operations occurring in an access point, such as access point 105, as the access point transmits downlink data to stations.

Operations 600 may begin with the access point transmitting a TIM to stations that it is serving (block 605). The TIM may include a bitmap of stations served by the access point and for stations that the access point has buffered downlink data, the access point may set corresponding bits accordingly. The access point may periodically broadcast the TIM to stations that it is serving.

In general, the TIM may be seen as a request for stations that are indicated by the TIM as stations with buffered downlink data at the access point to send to the access point a response indicating that they are ready to receive at least a portion of the downlink data. The response may be in the form of a PS-poll. The access point may receive PS-polls from at least some of the stations that are ready to receive at least a portion of the downlink data (block 610). The access point may attempt to decode the PS-polls (block 612). In other words, the access point attempts to decode the PS-polls and some of the PS-polls will be decodable and some of the PS-polls will not be decodable. Basically, the access point is determining if it is able to decode the PS-polls. Typically, the access point will be able to decode a PS-poll or it will be unable to decode a PS-poll. It is noted that in a CSMA-CD communications system, such as an 802.11 compliant communications system, that not every station having buffered downlink data at the access point as indicated by the TIM may be able to transmit the PS-poll to the access point.

The access point may generate a BlockAck bitmap in accordance with the PS-polls received from the stations (block 615). The BlockAck bitmap may be generated as described above in FIGS. 5a-5c and associated descriptions. Each bit of the BlockAck bitmap may be used as an indicator of whether or not the access point was able (or was unable) to decode the PS-polls. The access point may transmit the BlockAck bitmap in a modified BlockAck frame (block 620). The BlockAck frame may be transmitted after the polling period ends.

The access point may schedule at least some of the stations that sent PS-polls to receive their corresponding buffered downlink data and generate a DL Timing Grant frame from the downlink scheduling information (block 625). The DL Timing Grant frame may include identifying information for a station, and a time when the AP is going to transmit the downlink data for the station. The information may also include an amount of downlink data, a duration of the transmission, a MCS used by the AP, frequency information, and the like.

The access point may transmit the DL Timing Grant frame (block 630). The access point may broadcast the DL Timing Grant frame to the stations that it is serving. It is noted that the BlockAck frame and the DL Timing Grant frame may be separately encoded so that the two message frames may be transmitted separately, for example, the BlockAck frame may be transmitted before the DL Timing Grant frame. The access point may transmit buffered downlink data to the stations in accordance to information included in the BlockAck frame and the DL Timing Grant frame.

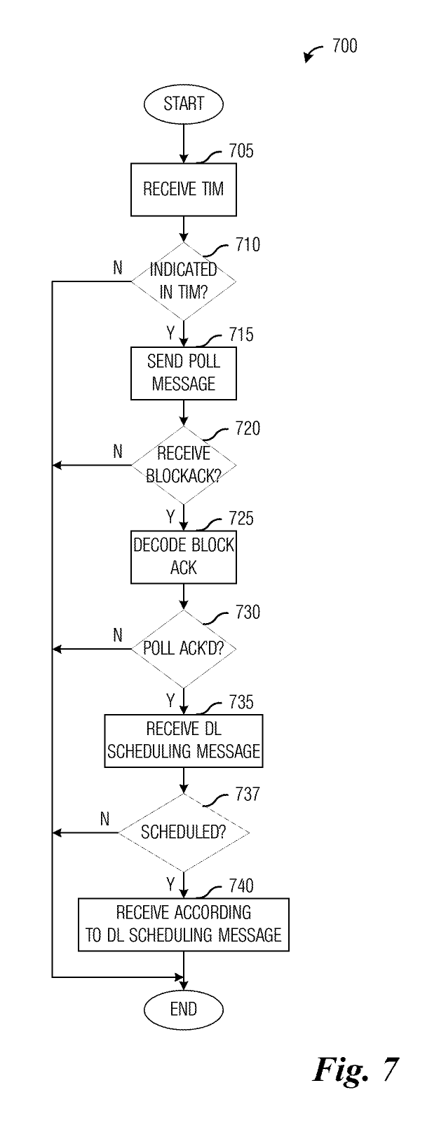

FIG. 7 illustrates a flow diagram of operations 700 occurring in a station as the station receives a downlink transmission from an access point. Operations 700 may be indicative of operations occurring in a station, such as stations 110-134, as the station receives a downlink transmission from an access point serving the station.

Operations 700 may begin with the station receiving a TIM (block 705). The TIM may have been carried in a Beacon frame that is broadcasted by the access point and includes a TIM bitmap that indicates which stations the access point has buffered downlink data. As an example, the TIM bitmap may have a bit representing each station and if the bit for a particular station is set to a first value, such as “1,” the access point has buffered downlink data for the particular station, and if the bit is set to a second value, such as a “0,” the access point does not have buffered downlink data for the particular station.

The station may decode the TIM to determine if it has been indicated as having buffered downlink data stored at the access point (block 710). Generally, the station determines which bit in the TIM bitmap corresponds to it and checks the value of the bit to see if there is buffered downlink data for it at the access point. It is noted that techniques for decoding the TIM are beyond the scope of the example embodiments and are not discussed in detail herein. If the station has not been indicated as having buffered downlink data stored at the access point, operations 700 may terminate.

If the station has buffered downlink data stored at the access point, the station may send a message frame, such as a PS-poll frame to the access point (block 715). The TIM may be considered to be an invitation to transmit a message frame to the access point, wherein stations indicated in the TIM bitmap may be invited to transmit a message frame to the access point to indicate that the station is ready to receive data from the AP. It is noted that the station must contend for access to the communications channel and may transmit the message frame only if it is successful in obtaining access to the communications channel. Therefore, if the WLAN is congested, it is not ensured that every station indicated as having buffered downlink data at the access point will be able to transmit a message frame to the access point.

The station may receive a block acknowledgement message frame (i.e., a BlockAck frame) from the access point (block 720). As discussed previously, the BlockAck frame may include a BlockAck bitmap that includes multiple acknowledgements for message frames transmitted by stations as received at the access point. If the station received the BlockAck frame, the station may decode the BlockAck bitmap to determine if the access point was able to receive (and/or decode) its message frame to the access point (block 725).

The station may perform a check to determine if the access point has acknowledged its message frame to the access point (block 730). If the access point has acknowledged its message frame, the station may receive a DL Timing Grant frame (block 735). As discussed previously, the DL Timing Grant frame may include information that tells the station whether, where (i.e., a frequency, channel, band, and the like) and/or when (i.e., a time, frame, block, and the like) the station will be able to receive its downlink data. The station may perform a check to determine whether it has been scheduled for receiving downlink data from the AP (block 737). If yes, the station may receive its downlink data in accordance with the information of where and when that is included in the DL Timing Grant frame (block 740).

If the station did not receive the block acknowledgement message frame (block 720), operations 700 may terminate. If the access point did not acknowledge the station's message frame to the access point (block 730), i.e., the access point did not receive the message frame or the access point was not able to successfully decode the message frame, operations 700 may terminate. If the DL Timing Grant frame that the station received indicates that the station has not been scheduled for receiving downlink data (block 737), operations 700 may terminate.

It is noted that if the station transmits the message frame, e.g., the PS-poll frame, but the access point did not acknowledge the receipt of the message frame in the BlockAck frame, the station may try to re-transmit the message frame in a non-contention-free period after the access point and other stations perform contention-free downlink data transmissions. It is also noted that if the DL Timing Grant frame that the station received indicates that the station has not been scheduled for receiving downlink data (block 737), the station may remain awake to receive downlink data in a non-contention-free period after the access point and other stations perform contention-free downlink data transmissions.

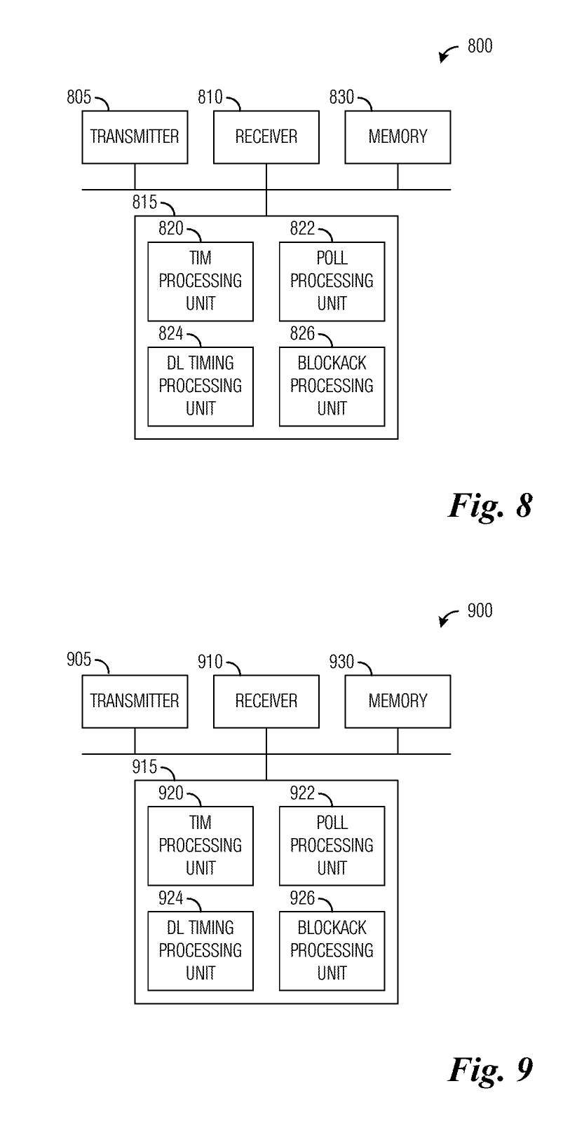

FIG. 8 illustrates a first communications device 800. Communications device 800 may be an implementation of a communications controller, such as a base station, an access point, a NodeB, an eNB, a base terminal station, and the like. Communications device 800 may be used to implement various ones of the embodiments discussed herein. As shown in FIG. 8, a transmitter 805 is configured to transmit Beacon frames, TIMs, TIM bitmaps, BlockAck frames, BlockAck bitmaps, DL Timing Grant frames, packets, requests, indications, and the like. Communications device 800 also includes a receiver 810 that is configured to receive packets, message frames, PS-poll frames, and the like.

A TIM processing unit 820 is configured to generate a TIM bitmap of stations served by communications device 800 that have stored downlink data. TIM processing unit 820 is also configured to generate a TIM IE, which includes a TIM bitmap, for transmission to the stations served by communications device 800. A poll processing unit 822 is configured to process polls, such as PS-polls, from stations that are indicated in a TIM bitmap as stations with downlink data being buffered by communications device 800. A downlink timing processing unit 824 is configured to schedule downlink transmissions for stations that transmitted polls to communications device 800. Downlink timing processing unit 824 is also configured to generate downlink scheduling information from the scheduled stations. Downlink timing processing unit 824 is also configured to generate a downlink scheduling message frame (e.g., a DL Timing Grant frame) from the scheduled stations and the downlink scheduling information to transmit to the stations served by communications device 800. A BlockAck processing unit 826 is configured to generate a BlockAck bitmap from the results of decoding attempts of polls received by communications device 800. BlockAck processing unit 826 is also configured to generate a block acknowledgement message frame (e.g., a BlockAck frame) that includes the BlockAck bitmap to transmit to stations served by communications device 800. A memory 830 is configured to store Beacon frames, TIMs, TIM bitmaps, polls, poll decoding results, BlockAck bitmaps, block acknowledgement message frames, downlink scheduling information, downlink scheduling message frames, downlink data, and the like.

The elements of communications device 800 may be implemented as specific hardware logic blocks. In an alternative, the elements of communications device 800 may be implemented as software executing in a processor, controller, application specific integrated circuit, or so on. In yet another alternative, the elements of communications device 800 may be implemented as a combination of software and/or hardware.

As an example, receiver 810 and transmitter 805 may be implemented as a specific hardware block, while TIM processing unit 820, poll processing unit 822, downlink timing processing unit 824, and BlockAck processing unit 826 may be software modules executing in a microprocessor (such as processor 815) or a custom circuit or a custom compiled logic array of a field programmable logic array. TIM processing unit 820, poll processing unit 822, downlink timing processing unit 824, and BlockAck processing unit 826 may be modules stored in memory 830.

FIG. 9 illustrates a second communications device 900. Communications device 900 may be an implementation of a station, such as mobile station, a mobile, a user, a terminal, a subscriber, a user equipment, and the like. Communications device 900 may be used to implement various ones of the embodiments discussed herein. As shown in FIG. 9, a transmitter 905 is configured to transmit polls, messages, and the like. Communications device 900 also includes a receiver 910 that is configured to receive packets, messages, TIMs, block acknowledgement message frames, downlink scheduling message frames, and the like.

A TIM processing unit 920 is configured to process a TIM message and to determine if communications device 900 has buffered downlink data at an access point serving communications device 900. A poll processing unit 922 is configured to transmit a poll, such as a PS-poll, if communications device 900 has buffered downlink data at the access point. A downlink timing processing unit 924 is configured to process a downlink scheduling message frame to determine whether, where and/or when communications device 900 can receive its downlink data. A BlockAck processing unit 926 is configured to process a block acknowledgement message frame to determine if the access point successfully received a poll transmitted by communications device 900. A memory 930 is configured to store TIMs, TIM bitmaps, BlockAck bitmaps, block acknowledgement message frames, downlink scheduling information, downlink scheduling message frames, downlink data, and the like.

The elements of communications device 900 may be implemented as specific hardware logic blocks. In an alternative, the elements of communications device 900 may be implemented as software executing in a processor, controller, application specific integrated circuit, or so on. In yet another alternative, the elements of communications device 900 may be implemented as a combination of software and/or hardware.

As an example, receiver 910 and transmitter 905 may be implemented as a specific hardware block, while TIM processing unit 920, poll processing unit 922, downlink timing processing unit 924, and BlockAck processing unit 926 may be software modules executing in a microprocessor (such as processor 915) or a custom circuit or a custom compiled logic array of a field programmable logic array. TIM processing unit 920, poll processing unit 922, downlink timing processing unit 924, and BlockAck processing unit 926 may be modules stored in memory 930.

Although the present disclosure and its advantages have been described in detail, it should be understood that various changes, substitutions and alterations can be made herein without departing from the spirit and scope of the disclosure as defined by the appended claims.

What is claimed is:

1. A method for acknowledging messages, the method comprising:
receiving, by an access point, a polling message from a plurality of stations served by the access point;
determining, by the access point, if the access point is able to decode the polling message received;
generating, by the access point, a block acknowledgement bitmap (BAB) including an indication of a result of the determining if the access point is able to decode the polling message; and
broadcasting, by the access point, the BAB to the plurality of stations.

2. The method of claim 1, further comprising transmitting a traffic indicator map (TIM) indicating that the access point has transmissions to a superset of the plurality of stations, the TIM including a transmission indicator for each station served by the access point.

3. The method of claim 2, wherein the indication in the BAB comprises an acknowledgement indicator for each station in the superset of the plurality of stations.

4. The method of claim 3, further comprising applying one of a rotation and a cyclic shift to the indication in the BAB.

5. The method of claim 3, further comprising applying a permutation to the indication in the BAB.

6. The method of claim 1, wherein the polling message comprises a power saving poll (PS-poll) message.

7. The method of claim 1, further comprising after broadcasting the BAB, broadcasting a downlink time grant message to a subset of the plurality of stations served by the access point.

8. The method of claim 7, wherein the BAB and the downlink time grant message are separately encoded, and wherein the BAB is transmitted before the downlink time grant message is transmitted.

9. The method of claim 1, wherein the polling message is received during a polling interval.

10. The method of claim 1, wherein the BAB is transmitted in a BlockAck message.

11. A method for operating a station, the method comprising:
transmitting, by the station, a polling message to an access point serving the station;
receiving, by the station, a block acknowledgement bitmap (BAB) from the access point, the BAB includes an indication of a result of a determining if the access point is able to decode the polling message; and
receiving, by the station, a downlink time grant message from the access point.

12. The method of claim 11, further comprising receiving a downlink transmission from the access point in accordance with the downlink time grant message.

13. The method of claim 11, further comprising receiving a traffic indicator map from the access point, the traffic indicator map indicating that the access point has a downlink transmission for the station.

14. The method of claim 11, wherein the polling message is a power saving poll (PS-poll) message.

15. The method of claim 11, wherein the indication in the BAB indicates that the access point is able to decode the polling message.

16. The method of claim 11, wherein the BAB is received prior to the downlink time grant message.

17. The method of claim 11, wherein the BAB and the downlink time grant message are separately encoded.

18. An access point comprising:
a receiver configured to receive a polling message from a plurality of stations served by the access point;
a processor operatively coupled to the receiver, the processor configured to determine if the access point is able to decode the polling message received, and to generate a block acknowledgement bitmap (BAB) including an indication of a result of the determining if the access point is able to decode the polling message; and
a transmitter operatively coupled to the processor, the transmitter configured to broadcast the BAB to the plurality of stations.

19. The access point of claim 18, wherein the transmitter is configured to transmit a traffic indicator map (TIM) indicating that the access point has transmissions to a superset of the plurality of stations, the TIM including a transmission indicator for each station served by the access point.

20. The access point of claim 19, wherein the indication in the BAB comprises an acknowledgement indicator for each station in the superset of the plurality of stations.

21. The access point of claim 18, wherein the transmitter is configured to broadcast a downlink time grant message to a subset of the plurality of stations served by the access point.

22. The access point of claim 21, wherein processor is configured to separately encode the BAB and the downlink time grant message.

23. A station comprising:
a transmitter configured to transmit a polling message to an access point serving the station; and
a receiver operatively coupled to the transmitter, the receiver configured to receive a block acknowledgement bitmap (BAB) from the access point, the BAB includes an indication of a result of a determining if the access point is able to decode the polling message, and to receive a downlink time grant message from the access point.

24. The station of claim 23, wherein the receiver is configured to receive a downlink transmission from the access point in accordance with the downlink time grant message.

25. The station of claim 23, wherein the receiver is configured to receive a traffic indicator map from the access point, the traffic indicator map indicating that the access point has a downlink transmission for the station.
